(19) United States
(12) Patent Application Publication
(10) Pub. No.: US 2024/0336441 A1
(43) Pub. Date: Oct. 10, 2024

(54) Conveyor Apparatus for Conveying Motor Vehicle Bodies, Method for Painting a Motor Vehicle Body, and Painting Apparatus

(71) Applicant: Bayerische Motoren Werke Aktiengesellschaft, Muenchen (DE)

(72) Inventors: Alexander GEISBERGER, Hajdúszoboszló (HU); Niklas RESTER, Muenchen (DE); Alexander SCHOENHUBER, Debrecen (HU); Gerhard STEURER, Roehrmoos (DE)

(21) Appl. No.: 18/576,538

(22) PCT Filed: Jun. 24, 2022
(86) PCT No.: PCT/EP2022/067345

§ 371 Date: Jan. 4, 2024

(30) Foreign Application Priority Data
Jul. 5, 2021 (DE) 10 2021 117 219.5

(51) Int. Cl. B65G 17/12; B05B 16/00; B65G 45/10

(52) U.S. Cl. CPC B65G 17/12; B05B 16/95; B65G 45/10; B65G 2201/0294

(57) ABSTRACT

A conveying apparatus for conveying a motor vehicle body along a conveying path includes a chain conveyor that has a chain strand which circulates along the conveying path. Fixedly receiving elements and loosely receiving elements are alternately disposed on the chain strand at a predefined interval from each other over an entire length of the chain strand and are movable along the conveying path by the chain strand. A respective fixedly receiving element is configured to receive and secure a first crossmember which is releasably connected to the motor vehicle body and a respective loosely receiving element has a deposition region on which a second crossmember which is releasably connected to the motor vehicle body is supportable.

### BACKGROUND AND SUMMARY

The invention relates to a conveying apparatus for conveying motor vehicles, in particular during painting. The invention also relates to a method for painting a motor vehicle body. Lastly, the invention relates to a painting apparatus for painting a motor vehicle body.

One of the greatest challenges when painting large workpieces is the transport of the workpieces itself. Large workpieces may be, in particular, motor vehicle bodies. Since the motor vehicle bodies generally do not have any wheels prior to the final assembly, the motor vehicle bodies manufactured during body construction have to be transported for example by means of body receptacles, fixings and/or mounts. It is thus possible for the in particular semifinished motor vehicle bodies to be transported through different production steps of the vehicle manufacture, such as through a paint shop.

EP 0 271 008 B1 discloses a conveying apparatus for conveying motor vehicle bodies.

It is the object of the present invention to provide a conveying apparatus and a painting method and a painting apparatus, by which vehicle bodies can be painted in series production advantageously and in particular with a flexible cycle interval, the painting being effected in particular in spray booths.

A first aspect of the invention relates to a conveying apparatus for conveying motor vehicle bodies, in particular for painting and conveying during the painting in the motor vehicle manufacture. The conveying apparatus according to the invention serves for conveying along a conveying path and comprises at least one chain conveyor, comprising at least one chain strand which circulates along the conveying path and on which, over its entire length, in each case mutually alternating fixedly receiving elements and loosely receiving elements are arranged at a predefined interval relative to one another. These fixedly receiving elements and loosely receiving elements are movable along the conveying path by means of the chain strand and in particular with the chain strand, that is to say in each case fixedly connected to the chain strand and thus at the same speed. According to the invention, the respective fixedly receiving element is configured to receive a crossmember which is releasably connected to a motor vehicle body and to secure the crossmember, in particular in the conveying direction, and the respective loosely receiving element has a deposition region on which a further crossmember which is releasably connected to the motor vehicle body is supportable.

In other words, on the chain strand, a fixedly receiving element is followed by a loosely receiving element, which is in turn followed by a fixedly receiving element. In this case, a respective interval between a fixedly receiving element and a subsequent loosely receiving element is predefined, wherein a length of the chain strand is in particular an even multiple of the interval, such that a fixedly receiving element and a loosely receiving element are arranged on the chain strand in alternating fashion uniformly over the entire length thereof, and at the location where a “chain end” meets a “chain start”, a fixedly receiving element and a loosely receiving element also alternate.

Arranged on the respective vehicle body or motor vehicle body, in particular in a front region transversely with respect to the vehicle longitudinal direction and in a rear region transversely with respect to the vehicle longitudinal direction, in each case for example on the substructure, is a paint crossmember, the crossmember and the further crossmember. These serve as body mount for the conveyance of the motor vehicle body by means of the conveying apparatus.

In this case, for example, the respective body or motor vehicle body is for example screwed to in each two crossmembers in particular during the conveying by means of the conveying apparatus, the interval between the crossmembers on the motor vehicle body being selected such that it corresponds to the interval between the fixedly receiving elements and loosely receiving elements, and therefore the first of the crossmembers of the motor vehicle body is arranged in one of the fixedly receiving elements and the second crossmember is arranged in one of the loosely receiving elements. However, it is possible for a plurality of loosely receiving elements and fixedly receiving elements to be arranged between the two elements (fixedly receiving element and loosely receiving element) receiving the respective crossmember. The respective crossmember or paint crossmember may in particular be configured in such a way that it has, in principle, a transverse guide for the positioning of the vehicle body perpendicularly with respect to the conveying direction, as a result of which the motor vehicle body can be arrested on the fixedly receiving elements and loosely receiving elements for a particularly advantageous painting operation.

In this case, the motor vehicle body is advantageously aligned in such a way that the crossmember lying at the front in the conveying direction or front crossmember is arranged in the fixedly receiving element and the rear crossmember is arranged in the loosely receiving element. Here, the conveying direction is the direction in which the vehicle bodies are transported on the conveying path.

The chain strand comprises, in particular, a plurality of chain links, the circulating of the chain strand along the conveying path meaning that for example a gearwheel or a sprocket is arranged for example at a respective end of the conveying path, that is to say at the beginning of the conveying path and at the end of the conveying path, the gearwheel or sprocket being able to deflect the chain strand at the respective end. The chain strand may for example be oriented horizontally, and therefore that part of the chain strand which is conveyed in the conveying direction when circulating around the conveying path runs above that part of the chain strand which is conveyed back in a direction opposite to the conveying direction. The conveying path may also be only a section of a total path, which may thus be formed for example from a plurality of lined-up chain strands.

Here, the invention is based on the knowledge that vehicle bodies, which are painted successively, are fastened to skids for the conveying during the painting. The painting is in particular what is known as a topcoat process. In contrast thereto, the use of the crossmembers and of the conveying apparatus according to the invention affords the advantage that, for example, an interval for example of 2610 millimeters, which is the same across derivatives, can be maintained between the two paint crossmembers on the motor vehicle body. It is thus possible for motor vehicle bodies of different vehicle models to be conveyed in a simple manner by the conveying apparatus according to the invention in spite of different vehicle lengths and overhangs at the front and/or at the rear. A further advantage of the conveying apparatus according to the invention, in particular when it is used in a paint shop but also generally, is the saving on cycle time in the case of different cycle intervals of the individual bodies relative to one another (need for a larger interval for the subsequent body relative to the previous body when changing color in the total system of uniform longitudinal conveying technology speed). The advantage of the very low space requirement can be attributed, in particular, to the omission of the return path and storage structure for the conventional skids in conventional topcoat conveying technology.

The use of skids is thus omitted in the conveying technology, which affords further advantages, in particular for example a low initial investment due to omission of the acquisition costs for a plurality of skids. In addition, the cleaning of the skids is completely omitted, wherein the cleaning would be carried out not on the conveying apparatus or at the paint shop but generally at a remote location, as a result of which transport for the cleaning is for example also omitted. A further advantage is the omission of the return paths for empty skids, which are generally moved for example over roller tracks. It is thus for example possible to achieve a considerable space saving as a result of the chain conveyor. This also results, for example, in greater design freedom in the planning or arrangement of manufacturing processes or the configuration of the paint shop in the vehicle manufacture. In addition, a further advantage is that for example storage and stacking of skids is omitted, which would for example have to be incorporated in the return paths in order to compensate for process downtimes. This in turn results in further space savings. Overall, the conveying apparatus according to the invention makes it possible to realize a considerable simplification of the complexity while simultaneously involving particularly low costs. In addition, the outlay in terms of maintenance of the conveying apparatus is also lower.

In an advantageous configuration of the invention, the chain conveyor comprises at least one chain drive, the drive gear of which is arranged at one end of the conveying path and the output gear of which is arranged at the other end of the conveying path. In other words, the chain strand is driven by means of a drive gear, which is for example drivable by a motor, an output gear being provided around which the chain strand can be deflected for circulating purposes. In this case, the drive gear and/or the output gear may for example also be arranged at a reversal point of the chain strand, in particular for example if the conveying path is formed for example by a plurality of chain strands or comprises a plurality of lined-up conveying path partial regions. The chain drive affords the advantage that the conveying apparatus can be operated in a particularly advantageous manner.

In an advantageous configuration of the invention, provided on the conveying apparatus over the entire length, on at least one of the fixedly receiving elements and/or on at least one of the loosely receiving elements and/or on at least one chain link of the chain strand and/or on at least one of the crossmembers, is at least one transverse guide element. In other words, the transverse guide element is provided on one of the fixedly receiving elements, on one of the loosely receiving elements and/or on a chain link of the chain strand and/or a crossmember and is able to realize a stabilization, provided transversely with respect to the conveying direction and thus advantageously in the vehicle transverse direction of the vehicle body, during the conveying. As a result, it is for example particularly advantageously possible for the conveying to be carried out in a particularly precise manner, in order for the application of the paint for example by means of a spraying robot or painting robot to thus for example be able to be applied to the vehicle body in a particularly precise manner during a painting operation.

In a further advantageous configuration of the invention, a fixed bearing is arranged at a turning point of the chain strand, that is to say in particular at one end or the other of the conveying path. It is for example possible for in particular the front one of the crossmembers of the vehicle body to be synchronized in terms of control with a painting cycle by means of a control device, which is provided for controlling the conveying apparatus, as a result of which the motor vehicle body can be advantageously drawn through the painting process. This affords the advantage that particularly advantageously a position of the vehicle body can be predefined in particular in the vehicle longitudinal direction, that is to say in the conveying direction, as a result of which, for example, a clocking of a plurality of motor vehicle bodies conveyed by the conveying apparatus can be particularly high and simultaneously an overspray between motor vehicle bodies can be avoided.

In a further advantageous configuration of the invention, a drive of the chain conveyor is configured as a polygon compensation drive. In addition or as an alternative, the drive or a further drive comprises a cycloidal transmission. In other words, the chain strand is driven by means of a polygon compensation drive or a cycloidal transmission can be provided in a drive of the chain strand. The drive may in particular be configured as part of the chain drive. Here, in particular if the conveying apparatus is used for painting, a particularly great challenge is the tolerances along the vehicle coordinates. For example, owing to the absence of load carriers by which tolerances are predefinable, further alternative technical measures are used. The tolerance can be influenced by an additional cycloidal transmission, in particular by braking action of the cycloidal transmission, and therefore the latter may for example be flange-mounted as required on a drive station which comprises a drive.

A further challenge in the case of the conveying apparatus comprising the chain conveyor is what is known as the polygon effect, which occurs for example in the case of sprockets, and which can cause a fluctuating output speed with a constant drive speed, in particular since a traction mechanism, the chain strand, cannot run on and/or off in a circular manner, and therefore discontinuities of the traction mechanism occur. As a result, the speed of the chain strand changes periodically, wherein, in particular, the size of the percentage speed difference would increase as the number of teeth of the sprocket becomes smaller. This can particularly advantageously be smoothed or nullified by the polygon compensation drive.

In a further advantageous configuration of the invention, the interval between one of the fixedly receiving elements and the subsequent loosely receiving element corresponds to a crossmember interval between the crossmember and the further crossmember of between 2000 and 3000 millimeters, in particular 2610 millimeters. In other words, the interval between the fixedly receiving element and the subsequent loosely receiving element is an essentially integer factor of the crossmember interval. This essentially means that for example play between individual chain links and/or manufacturing tolerances are correspondingly taken into account, wherein, in particular, a length of the deposition region can also be used for tolerance compensation. In other words, the two crossmembers mounted on the motor vehicle body for conveying purposes are spaced apart in such a way that when the motor vehicle body is introduced onto or mounted on the conveying apparatus, in which case the front crossmember is mounted on a fixedly receiving element, the rear crossmember can always be arranged on the deposition region of a loosely receiving element. This affords the advantage that the conveying apparatus can particularly advantageously be used for conveying the motor vehicle bodies.

In a further advantageous configuration of the invention, a cleaning device is provided, through which the chain strand is able to pass in a direction opposite to a conveying direction. In other words, the chain strand circulating along the conveying path can, in particular on its return path, that is to say for example in particular on a bottom side of the conveying path, be drawn through a cleaning apparatus. In this case, the cleaning apparatus serves for example for automated cleaning of paint residues on the receiving elements, that is to say the fixedly receiving elements and the loosely receiving elements. The cleaning apparatus may comprise, for example, dry ice and/or an ultrasonic water bath and/or brushes and/or cleaning media. In addition or furthermore, a high-pressure cleaning by means of water jet and/or a squeezing and/or displacement of excess paint may be effected. This affords the advantage that the conveying apparatus can particularly advantageously be used during the painting of motor vehicle bodies.

A second aspect of the invention relates to a method for painting a motor vehicle body. In the method, paint is applied to the motor vehicle body in a painting region for example by means of a spraying robot and/or a painting robot. In this case, during the application of the paint, the vehicle body is conveyed, by means of a conveying apparatus presented here, along the conveying path on which in particular the painting region is arranged. According to the invention, in the method the front one of the two crossmembers connected to the motor vehicle body is received by the fixedly receiving element. This means that the second or further one of the two crossmembers connected to the motor vehicle body lies on the deposition region of a loosely receiving element on account of the predefined interval between the fixedly receiving elements and the loosely receiving elements.

Here, advantages and advantageous configurations of the first aspect of the invention are regarded as advantages and advantageous configurations of the second aspect of the invention and vice versa.

In an advantageous configuration of the method, the motor vehicle body is introduced into the painting region by the conveying apparatus with predefined clocking. In other words, the motor vehicle body is introduced in the painting region in a manner coordinated in accordance with the application of the paint for example by the painting robot and thus coordinated with a painting duration or clocking of the painting process, and therefore the paint can in particular be particularly advantageously applied to the motor vehicle body, and thus for example in the case of a color change by the painting robot for a further motor vehicle body to be introduced, mixing of the two colors in, for example, end or starting regions of the vehicle body can be avoided.

A third aspect of the invention relates to a painting apparatus for painting a motor vehicle body. In this case, the painting apparatus according to the invention is configured to carry out the method presented here and/or the painting apparatus comprises a conveying apparatus designed as presented here.

Advantages and advantageous configurations of the first and second aspect of the invention are thus regarded as advantages and advantageous configurations of the third aspect of the invention, and the reverse is also true in each case.

Further features of the invention will emerge from the claims, from the figures and from the description of the figures. The features and feature combinations mentioned above in the description, and the features and feature combinations mentioned below in the description of the figures and/or shown only in the figures, may be used not only in the respectively specified combination but also in other combinations or individually.

The invention will now be discussed in more detail on the basis of a preferred exemplary embodiment and with reference to the drawings.

### BRIEF DESCRIPTION OF THE DRAWINGS

FIG. 1 shows a schematic side view of a detail of a conveying apparatus for conveying a motor vehicle body;

FIG. 2 shows a schematic perspective view of chain links of a chain strand of a chain conveyor of the conveying apparatus according to FIG. 1;

FIG. 3 shows a schematic side view of the chain links in FIG. 2; and

FIG. 4 shows a schematically sectional side view of part of a conveying path of the conveying apparatus with a cleaning apparatus.

### DETAILED DESCRIPTION OF THE DRAWINGS

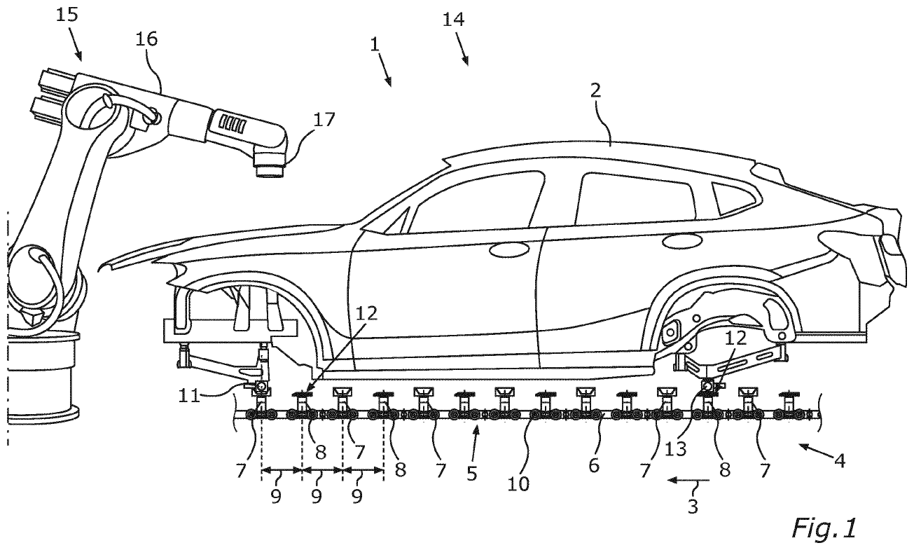

FIG. 1 shows a schematic side view of a conveying apparatus 1 for conveying motor vehicle bodies 2. The respective motor vehicle body 2 can be conveyed in a conveying direction 3, which in the exemplary embodiment coincides with the vehicle longitudinal direction, along a conveying path 4, a detail of which is shown. To this end, the conveying apparatus 1 comprises a chain conveyor 5, comprising at least one chain strand 6 which circulates along the conveying path 4 and on which, over its entire length, in each case mutually alternating fixedly receiving elements 7 and loosely receiving elements 8 are arranged at a predefined interval relative to one another. The fixedly receiving elements 7 and loosely receiving elements 8 are movable along the conveying path 4 by means of the chain strand 6 and in particular with the chain strand 6, that is to say at the same speed, since they are for example fixedly connected to a respective chain link 10 of the chain strand 6. The respective fixedly receiving element 7 is configured to receive a crossmember 11 which is releasably connected to the motor vehicle body 2 and to secure the crossmember, in particular in the conveying direction 3. The respective loosely receiving element 8 has a deposition region 12 on which a further crossmember 13 which is releasably connected to the motor vehicle body 2 is supportable. The chain links 10 thus form the chain strand 6 or a chain.

The length of the chain strand 6 corresponds in particular to an even multiple of the interval 9, and therefore a loosely receiving element 8 is followed by a fixedly receiving element 7 at a “chain start” or “chain end” which meets the “chain start”, that is to say at the location where a first and a last chain link 10 are joined.

The conveying apparatus 1 may in particular be, for example, a component of a painting apparatus 14, which for example comprises a painting robot 15 which has a robot arm 16 with a spraying tool 17 arranged thereon. In this case, the spraying tool 17 can apply paint to the motor vehicle body 2.

The painting apparatus 14 shown and the conveying apparatus 1 are thus particularly advantageously suitable for carrying out a method for painting the motor vehicle body 2, in which method paint is applied to the motor vehicle body 2 in a painting region, in which the painting robot 15 is arranged, while the motor vehicle body 2 is conveyed along the conveying path 4 in the conveying direction 3 by means of the conveying apparatus 1, the front crossmember 11 of the two crossmembers 11 and 13 connected to the motor vehicle body 2 being received by one of the fixedly receiving elements 7.

The conveying apparatus 1 shown, the method presented and the painting apparatus 14 make it possible to paint the motor vehicle body 2 in a particularly advantageous manner, without needing to resort for example to complicated and expensive body transport possibilities using skids.

The painting apparatus 14 serves in particular for painting the motor vehicle body 2 using topcoat.

A particular challenge, in particular for high cycle rates of motor vehicle bodies 2 during the painting, is a conveying attachment to the crossmembers 11 and 13, the paint crossmembers, without losses in flexibility in particular in relation to an installation output of the painting apparatus 14 or of the conveying apparatus 1. In order to meet this challenge, a robot configuration of the painting robot 15 may advantageously be based, in top layer operation, on what is known as line tracking, in which continuous conveying operation is intended to be obtained at for example around five meters per minute.

With the conveying apparatus 1, continuous conveyance during the painting is possible-in contrast thereto, when conveying using skids, only a stop-and-go conveyance is possible. As a result, in the case of the conveying apparatus 1 shown and the painting apparatus 14, a considerable saving on production line length can be obtained, which may for example result in particularly high investment savings, since for example particularly large halls which comprise a paint shop can be dispensed with. In addition, in the stop-and-go method, the body is secured at one location for an entire cycle time, and then has to be transported as quickly as possible to a next production positioning holding point.

What are known as shoes 19 are advantageously provided. For example, a fixed bearing for example in the form of a prism, which is synchronized in terms of control with the front crossmember 11, is provided at a turning point of the chain strand 6, and therefore the motor vehicle body 2 can be drawn through the painting region. On account of a required minimum interval of for example 1200 millimeters between two successive motor vehicle bodies 2 in order to avoid overspray on the subsequent motor vehicle body, an interval of for example 6700 millimeters arises, which is composed of a maximum vehicle body length of 5500 millimeters plus the minimum interval of 1200 millimeters. Thus, a fixed cycle interval of for example 7 meters at a cycle time of about 90 seconds would result. If a color change for example from red to blue in the base coat is then desired, a color change duration in the case of the painting robot 15 is typically 15 seconds. It would thus not be possible to accommodate a painting operation with a time window of 90 seconds, such that for example an enlarged gap between two motor vehicle bodies 2 could occur. As a result, in the case of a color change, the number of paintable motor vehicle bodies 2 would be reduced, as a result of which the painting apparatus 14 would not be able to be operated in a particularly efficient manner.

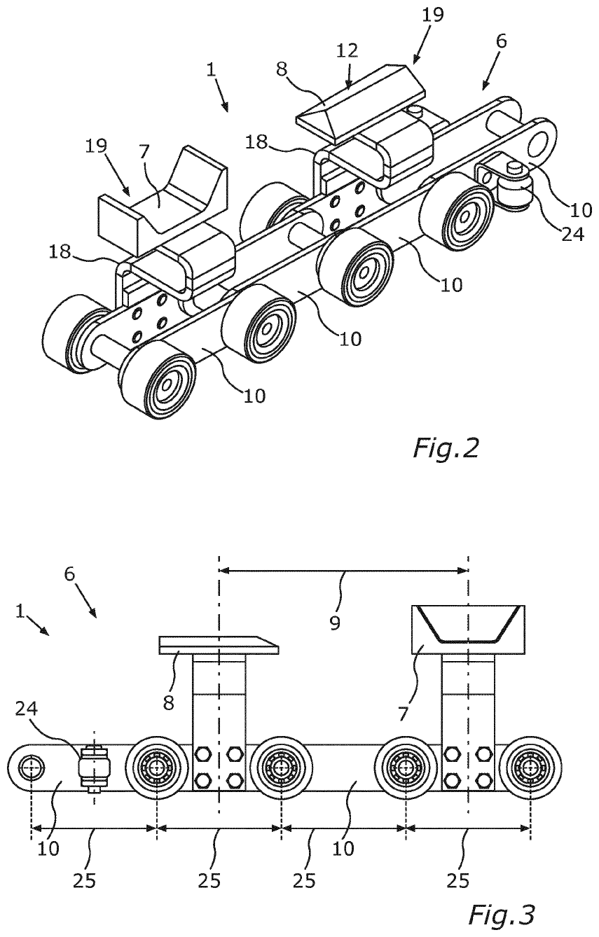

The conveying apparatus 1 shown makes it possible to avoid this problem, since a particularly high flexibility can be achieved by increasing the number of driver shoes, shoes 19 for short. In this case, the fixedly receiving elements 7 and the loosely receiving elements 8 form the shoes 19. FIG. 2 shows a schematic perspective view of a piece of the chain strand 6, which shows four chain links 10, shoes 19 being arranged on two of the chain links 10. A multiplicity of shoes 19 makes it possible to achieve, for example, a cycle interval of 6644 millimeters. The respective fixedly receiving element 7 and the respective loosely receiving element 8 may be connected to the respective chain link by way of a swan neck 18. The shoe 19 and/or the swan neck 18 may in particular additionally be provided as a respective transverse guide element for stabilization in a vehicle transverse direction during the conveying of the motor vehicle body 2. In addition or as an alternative, a side guide of the chain or of the chain strand 6 is provided by the transverse guide element 24.

Advantageously, the interval between one of the fixedly receiving elements 7 and the subsequent loosely receiving element 8 is provided with a crossmember interval between the crossmember 11 and the further crossmember 13 of between 2000 and 3000 millimeters and in particular at the mentioned 2610 millimeters.

If the crossmember interval were to be less than 2000 millimeters, there would be increased instability during the body transport in particular on account of tilting moments along the vehicle longitudinal direction. In the case of a crossmember interval of greater than 3000 millimeters, a body attachment point for the crossmembers 11 and 13 might be arranged disadvantageously on the motor vehicle body 2, owing to lower bending strength. Advantageously, the design of the shoe 19 is provided on a transverse guide, that is to say along the vehicle transverse direction and thus in particular substantially perpendicularly with respect to the conveying direction 3. Owing to interrelationships in the shoe design and the shoe interval, the crossmember interval and the total number of shoes 19, there is a particularly high complexity for the configuration of the conveying apparatus 1. Overall, it has proven advantageous to implement an interval of 478 millimeters (four times the length of a chain link 10) between the shoes 19 in the case of a cycle interval of 6674 millimeters between motor vehicle bodies 2, in order to in particular be able to obtain a high throughput during the painting.

For a pitch, a value of between 200 millimeters and 4000 millimeters is advantageous. Smaller than 200 millimeters is difficult to implement on account of a minimum length of carrying chain conveying carriages. An industry-typical body interval when painting in a topcoat line does not exceed eight meters, therefore more than 4000 millimeters is also difficult to implement on account of minimum requirements (half pitch), that is say in the case of a half cycle interval in relation to a body interval.

FIG. 3 shows a schematic side view of the part of the chain strand 6 according to FIG. 2. Here, a link length 25 of the respective chain link 10 is depicted; this may for example be between 118 and 119 millimeters. The interval 9 may for example be 237 millimeters. The advantageous dimensions mentioned in the exemplary embodiment are not limiting, but rather serve merely as an example.

FIG. 3 also shows a part of a chain drive, which may be configured as a drive gear 22, at a reversal point or turning point 21, an output gear (not shown) of the chain drive being able to be provided at an end of the conveying path 4 opposite to the drive gear 22.

A challenge for a conveying apparatus 1 or a painting apparatus 14 is in each case the cleaning thereof. Automated cleaning should advantageously be provided, which can for example ensure soiling prevention and overspray clean-up to obtain particularly advantageous painting quality when applying the paint by means of the painting robot 15.

In the case of the painting apparatus 14, the painting region, in which the painting robot 15 is located, is configured for example as a clean room, in order to obtain a particularly high paint quality. Thus, it may be a problem that, in the case of a new pass, for example owing to different cycle intervals, individual loosely receiving elements 8 and/or fixedly receiving elements 7 may be a crossmember receiving point, which it was not previously. If overspray is located thereon, as excess applied paint, this excess paint, which is located on the shoes 19, the swan necks 18 and in particular on the fixedly receiving elements 7 and loosely receiving elements 8 and which has been deposited in a previous pass, would be pushed away and/or freed by interference fit of the crossmembers 11 and 13, which may have a considerable negative effect on a painting quality. A cleaning by means of a cleaning apparatus 20 is therefore particularly advantageous.

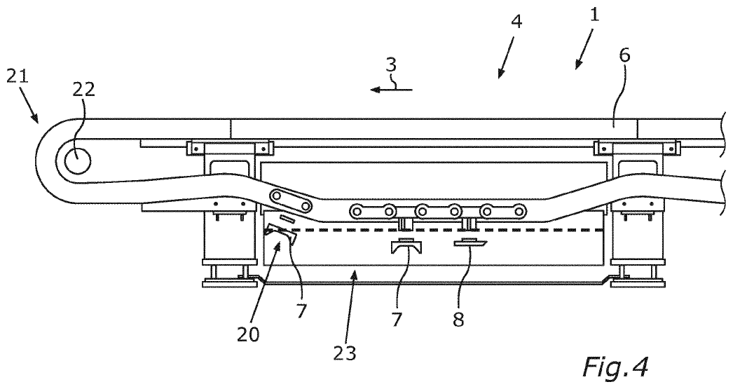

FIG. 4 shows part of the conveying path 4, the cleaning apparatus 20 being arranged in a lower region in which the chain strand 6 runs back to a starting point in a direction opposite to the conveying direction 3.

Overall, the requirements, which are particularly advantageously achieved by the conveying apparatus 1, are that cleaning cycles can be achieved which are adapted in accordance with a cycle interval that can be achieved by the chain strand 6. It is also necessary to ensure a conductivity of the swan necks 18 of 100 percent at any point in time, in order to be able to apply the paint in a particularly advantageous manner. Cleaning possibilities also must not impair the function of the chain strand 6. In addition, the dirt for example as a result of the overspray should be disposed of automatically. As a result of the elimination of dirt residues, a fire load can be reduced or no fire load is accumulated. Advantageously, maintenance and cleaning of the cleaning apparatus 20 must be able to be effected during the normal painting process and thus for example in less than 30 minutes. In addition, the cleaning apparatus 20 should be particularly compatible with paint, in particular with regard to used chemicals, dust and dirt.

To this end, the cleaning apparatus 20 may for example be a bath. The bath is for example a water bath which is subjected to ultrasound and through which the swan necks 18 and/or the fixedly receiving elements 7 and loosely receiving elements 8—that is to say the shoe 19—can particularly advantageously be drawn and thus cleaned. In addition or as an alternative, dry ice, brushes, a high-pressure cleaning and/or squeezing or displacement operation may be provided for the cleaning of the chain strand 6 by the cleaning apparatus 20. Advantageously, a combination of mechanical cleaning and use of release agents is effected, in order to enable a functional cleaning in the context of the mentioned requirements.

In this case, the cleaning apparatus 20 is configured, and coordinated, in such a way that the cleaned components—chain links 10, fixedly receiving elements 7, loosely receiving elements 8, swan necks 18 and shoes 19—do not need to have smooth surfaces, but they satisfy the functional requirements of the conveying apparatus 1. By way of example, one of the functional requirements, in particular if the paint is applied electrostatically, is that a respective conductivity be maintained.

Advantageously, during the installation of the chain conveyor 5 of the conveying apparatus 1, the chain strand is first wetted by means of a release agent, for example grease according to the corresponding specification, and installed. The cleaning is effected by, for example, a rotating brush-scraper system, which may be part of the cleaning apparatus 20 and which alternately wipes, brushes and/or scrapes relevant elements. The removal operation produces waste which can be conveyed out through, for example, a special discharge chute 23. Advantageously, a device is provided which can re-wet the chain strand 6 in an areal manner by means of airless application. In this case, the cleaning apparatus 20 is in particular arranged in modular fashion below the conveying path 4, with the result that the cleaning apparatus can be removed for example in a particularly simple manner in the event of maintenance and/or repair. By means of an interval control for example by a control apparatus, the cleaning is for example carried out correspondingly during the control of the conveying apparatus 1 or the painting apparatus 14.

The conveying apparatus 1 shown, the painting apparatus 14 and the method shown thus make it possible to maintain a permanent operation during the painting of motor vehicle bodies 2, which requires particularly small external interventions. A conveying technology is thus provided which can be used in continuous operation—the line tracking—in the process region of painting processes in particular in the form of base coat and/or clearcoat applications within a paint shop during the motor vehicle construction. Here, a particular feature is a skid-free operation with flexible cycle interval and automated cleaning apparatus 20 in the chain return path of the circulating chain strand 6.

### LIST OF REFERENCE CHARACTERS

1 Conveying apparatus
2 Motor vehicle body
3 Conveying direction
4 Conveying path
5 Chain conveyor
6 Chain strand
7 Fixedly receiving element
8 Loosely receiving element
9 Interval
10 Chain link
11 Crossmember
12 Deposition region
13 Further crossmember
14 Painting apparatus
Painting robot
16 Robot arm
17 Spraying tool
18 Swan neck
19 Shoe
20 Cleaning apparatus
21 Turning point
22 Drive gear
23 Discharge chute
24 Transverse guide element
25 Link length

1.-10. (canceled)

11. A conveying apparatus for conveying a motor vehicle body along a conveying path, comprising:
a chain conveyor that has a chain strand which circulates along the conveying path; and
fixedly receiving elements and loosely receiving elements, wherein the fixedly receiving elements and loosely receiving elements are alternately disposed on the chain strand at a predefined interval from each other over an entire length of the chain strand and are movable along the conveying path by the chain strand;
wherein a respective fixedly receiving element is configured to receive and secure a first crossmember which is releasably connected to the motor vehicle body;
wherein a respective loosely receiving element has a deposition region on which a second crossmember which is releasably connected to the motor vehicle body is supportable.

12. The conveying apparatus according to claim 11, wherein the chain conveyor has a chain drive with a drive gear which is disposed at a first end of the conveying path and an output gear which is disposed at a second end of the conveying path.

13. The conveying apparatus according to claim 11, wherein a transverse guide element is disposed on at least one of the fixedly receiving elements and/or on at least one of the loosely receiving elements and/or on at least one chain link of the chain strand and/or on at least one of the first crossmember and the second crossmember.

14. The conveying apparatus according to claim 11, wherein a fixed bearing is disposed at a turning point of the chain strand.

15. The conveying apparatus according to claim 11, wherein a drive of the chain conveyor is configured as a polygon compensation drive and/or the drive comprises a cycloidal transmission.

16. The conveying apparatus according to claim 11, wherein the predefined interval corresponds to a crossmember interval between the first crossmember and the second crossmember of 2000 mm to 3000 mm.

17. The conveying apparatus according to claim 11, further comprising a cleaning apparatus through which the chain strand is passable in a direction opposite to a conveying direction.

18. A method for painting a motor vehicle body, comprising the steps of:
applying paint to the motor vehicle body in a painting region while the motor vehicle body is conveyed along a conveying path by the conveying apparatus according to claim 11, wherein a front one of two crossmembers connected to the motor vehicle body is received by one of the fixedly receiving elements.

19. The method according to claim 18, wherein the motor vehicle body is introduced into the painting region by the conveying apparatus with predefined clocking.

20. A painting apparatus for painting a motor vehicle body, comprising:
the conveying apparatus according to claim 11 and/or wherein the painting apparatus is configured to perform the method according to claim 18.
